(19) United States
(12) Patent Application Publication
(10) Pub. No.: US 2017/0021595 A1
(43) Pub. Date: Jan. 26, 2017

(54) EXTRUSION AND ADHESIVE LAMINATIONS USING UNIQUE EXTRUSION COATED SEALANTS TO REPLACE WAX

(71) Applicant: American Packaging Corporation, Columbus, WI (US)

(72) Inventors: Brian Keith Muehl, Sherwood, WI (US); James W. Forster, Haydenville, MA (US); Louis Dolgin, Riverwoods, IL (US)

(73) Assignee: American Packaging Corporation, Columbus, WI (US)

(21) Appl. No.: 15/211,532

(22) Filed: Jul. 15, 2016

Related U.S. Application Data
(60) Provisional application No. 62/194,547, filed on Jul. 20, 2015.

(51) Int. Cl. B32B 15/09; B32B 27/32; B65D 17/00; B65D 85/76; B65D 6/02; B32B 27/36; B32B 37/12

(52) U.S. Cl. CPC B32B 15/09; B32B 27/36; B32B 27/32; B32B 37/1284; B65D 85/76; B65D 7/06; B65D 17/04; B65D 17/12; B32B 2439/70; B32B 2367/00; B32B 2323/04; B32B 2255/26; B32B 2255/06

(57) ABSTRACT

An improved lamination structure is disclosed for use as a packaging material, particularly a material formed by a combination of a foil layer with a PET layer with integral adhesive; and then applying a sealant polymer to the exposed PET surface. The resulting structure preferably exhibits adequate structure and sealing temperatures desirable for packaging of cream cheese and similar foodstuffs, and further exhibits flow and caulking while minimizing or avoiding impact to material deadfold.

This application claims priority under 35 USC §119(e) from U.S. Provisional Patent Application No. 62/194,547 for EXTRUSION AND ADHESIVE LAMINATIONS USING UNIQUE EXTRUSION COATED SEALANTS TO REPLACE WAX, filed Jul. 20, 2015 by B. Muehl et al., which is hereby incorporated by reference in its entirety.

Disclosed herein is an improved lamination structure for use as a packaging material, particularly a material suitable for use in the packaging of cream cheese and similar brick- or loaf-type product packages.

### BACKGROUND AND SUMMARY

Historically cream cheese brick- or loaf-type packaging (see e.g. for 8 oz., FIGS. 1A-1C), are provided in flexible packaging structures exhibiting structural formats of: For 8 oz., Over-lacquer/Ink/Foil/Adhesive/PET/Wax. At times starch or a release ingredient may be added to the wax. For 3# & 5190 Loafs, PET/Ink/PE/Wax/Starch-Release Ingredient. For 1# & 2# Loafs, Over-lacquer/Ink/MetPet/PE Wax/Starch-Release Ingredient. To better illustrate the details of an embodiment this disclosure will focus on the 8 oz. package. However, the concepts and package structures disclosed herein may be applied to other packaging sizes. The wax or wax-starch combination has been the sealant choice used for many years since it provides a very low seal-initiation temperature (approx. 150-160° F.), has adequate flow characteristics to caulk in the seal areas, provides additional deadfold properties in addition to the use of foil, and has adequate cheese release, in some instances due to the addition of starch type additives for certain cheese or cheese-like foodstuffs. This type of structure has been used for years and the filling equipment used to accommodate the structure has also been used for many years.

One particular example of a structure for eight-ounce cream cheese packages has the following characteristics: (i) Over-lacquer/(ii) Ink-Flexo or Roto Printed/(iii) Foil-(0.00033 to 0.00035″)/(iv) Poly Urethane Type Lamination Adhesive (applied in range of 1-3 #/ream (rm))/(v) 48ga PET/(vi) Wax Compounds (applied in range of 20-30#/rm). As used herein, the abbreviation “rm” is intended to refer to a “ream” and unless otherwise indicated a 3000 sq. ft. ream. The known structure and its reasonable cost has been effective in providing a low initial heat sealing temperature (HSIT) in the range of 150° F. to 165° F. as well as adequate hot tack such that it seals and holds that seal during filling, which can be at temperatures approaching 170° F. One feature of the wax layer is that the wax has the ability to flow into the seal areas to properly caulk the gusset area as well as side seals. The seal strength of the wax is low enough to allow the consumer to peel open the package without tearing the packaging material. Because the wax used as a sealant has a softening temperature below the package fill temperature (170° F.) it does not always insure a hermetic seal. The low HSIT and caulking characteristics reduce leakage rates and generally avoid open bottom seals. However, using wax as a sealant does not insure a hermetic seal, which is a desirable characteristic, particularly for a product susceptible to mold. Another advantage of the package structure is that there is very good deadfold for the pouch fabrication and filling process.

The embodiments disclosed herein seek to replicate or improve upon the performance of the known package materials. As part of the converting process for the known structure an embossed pattern may be placed into foil by a deep anilox roll that is employed in the application of the wax. The embossed pattern is shown in the pictures of FIG. 2 below. An embossed pattern may be applied to the embodiments of the new structure disclosed herein if desirable, and may be done either during or after the lamination process.

The general sealant structure summarized is also used for 1, 2, 3, and 5 pound loaves of cream cheese. For purposes of this document and to provide examples of materials and processes to replace wax as the sealant layer, the 8 oz. cream cheese structure will be used to further describe the structures and methods.

While the structure of FIGS. 1A-1C may appear to be somewhat of an ideal situation, the use of wax compounds limit the type of sealant options that may be employed for packaging. Relying on a full wax sealant may also be aligned too closely to petroleum refining and its relationship to gasoline refining thereby rendering the continuity of supply questionable, and at least subject to price variations, due to availability of refining capacity and raw material. The use of wax as a sealant requires application of the wax in the high range (e.g., weight/thickness) of about 25#/rm (pounds per 3000 sq. ft. ream). Other sealant options lend themselves to down-gauging possibilities since other polymers have different and more robust properties.

From a food safety perspective, dairy processors recognize the risks and shortened shelf life caused by the non-hermetic 100% wax seal. As a preferred manufacturing practice diary producers want to limit the amount of inorganic compounds admitted to their processing environments.

There have been attempts at using sealant films in the range of 1-2 mil thick low-density polyethylene (LDPE) in the packaging material structure to replace the wax sealant. In general, however, nearly 100% polyolefin type materials do not exhibit adequate HSIT and hot tack characteristics, and do not provide the flow and caulking needed for proper sealing when used on current filling equipment. Films also resist folding and will unfold when relaxed due to the elastic nature of polyethylene.

In accordance with the embodiments disclosed herein examples of the general structure contemplated are as follows: Over-lacquer/Ink/Foil/Adhesive/PET/Extrusion Coated Polymer(s). Applications for the improved packaging material structure Include cream cheese packaging, as illustrated in 8 oz. packages.

Disclosed in embodiments herein is a packaging material structure for use in a package, such as a three-side seal style pouch or a flow wrap with end seals and either a fin or lap seal in the machine direction of the package, comprising: a foil, and on one surface of said foil an ink layer along with an optional over-lacquer layer; an adhesive layer on the opposite side of the foil layer and a PET layer having an extrusion coated polymer(s) thereon.

Further disclosed in embodiments herein is a packaging material structure wherein the thickness of said foil is in the range of about 0.000285″ to about 0.00033″, where said adhesive layer includes a poly-urethane adhesive applied in range of about 1-3 lbs./ream (#/rm), where said PET layer has a thickness of about 48 gauge, and where the extrusion coated polymer is applied within a range of about 10-15#/rm.

Also disclosed herein is a packaging material structure wherein the thickness of said foil is in the range of about 0.000285″ to about 0.00033″, where said adhesive layer includes a poly-urethane adhesive applied in range of about 1-3 lbs./ream (#/rm), where said PET layer has a thickness of about 48 gauge, and where the extrusion coated polymer is a co-extrusion of a first and a second polymer applied within range of 10-15#/rm.

Further disclosed is a packaging material structure wherein the thickness of said foil is in the range of about 0.000285″ to about 0.00033″, where said adhesive layer includes a poly-urethane adhesive applied in range of about 1-3 lbs./ream (#/rm), where said PET layer has a thickness of about 48 gauge, and where the extrusion coated polymer is an extrusion coated hot melt applied within range of about 10-15#/rm.

Also disclosed in embodiments herein is a packaging material structure, further including a polyethylene (PE) extrusion lamination layer between the foil and the PET layer, where said polyethylene (PE) extrusion lamination layer is applied within range of about 4-7#/rm.

### BRIEF DESCRIPTION OF THE DRAWINGS

FIGS. 1A-1C are illustrations of a three-side seal style package;

FIG. 2 is an illustration of exemplary embossing applied in accordance with a feature of a disclosed embodiment;

FIG. 3 is a general diagram depicting the various layers in the disclosed packaging material structure;

FIGS. 4-8 are graphical illustrations of test data for various samples of the disclosed packaging structures, including differing sealant materials.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

As noted above, there is a need within the packaging industry to address sealant and structure options in order to provide alternatives to a full wax package sealant, particularly in three-side seal pouch style packages and fin seal flow wrap style packages, both of which may be employed to produce brick- or loaf-type package shapes. For example, the sealed seal horizontal flow wrap or three-side seal formed pouch may be used to encapsulate a brick of cream cheese or similar foodstuff where hermetic sealing may be desirable. The following discussion, while described relative a three-side seal style, is applicable to any package style or configuration, and particularly including a fin seal flow wrap style package. The embodiments disclosed herein present materials, material placement within a flexible packaging structure, and processing methodologies to resolves those challenges. The disclosed embodiments also result in potential ways to down gauge the structure, which in turn provides a more sustainable package by using less material especially less fossil fuel materials.

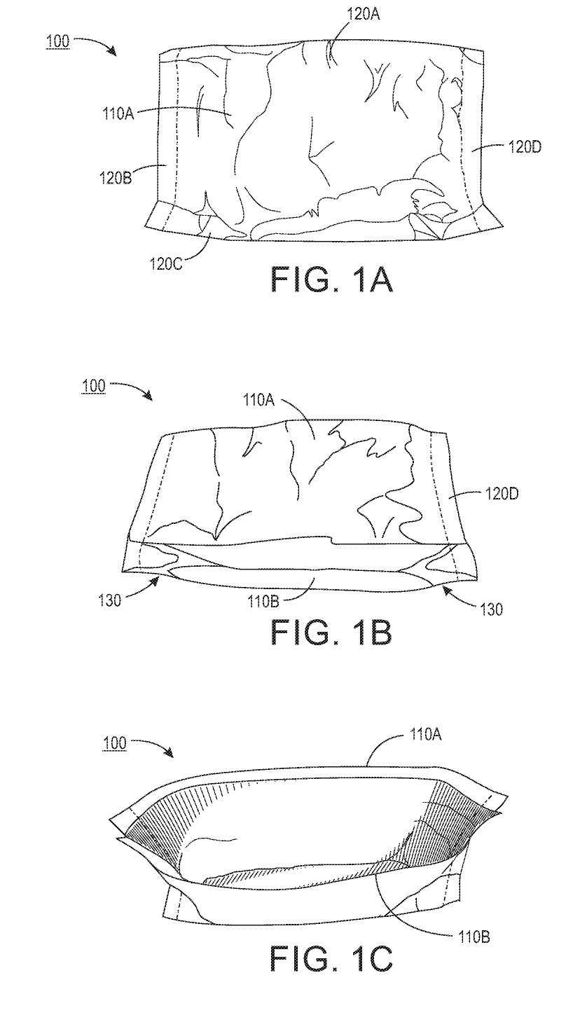

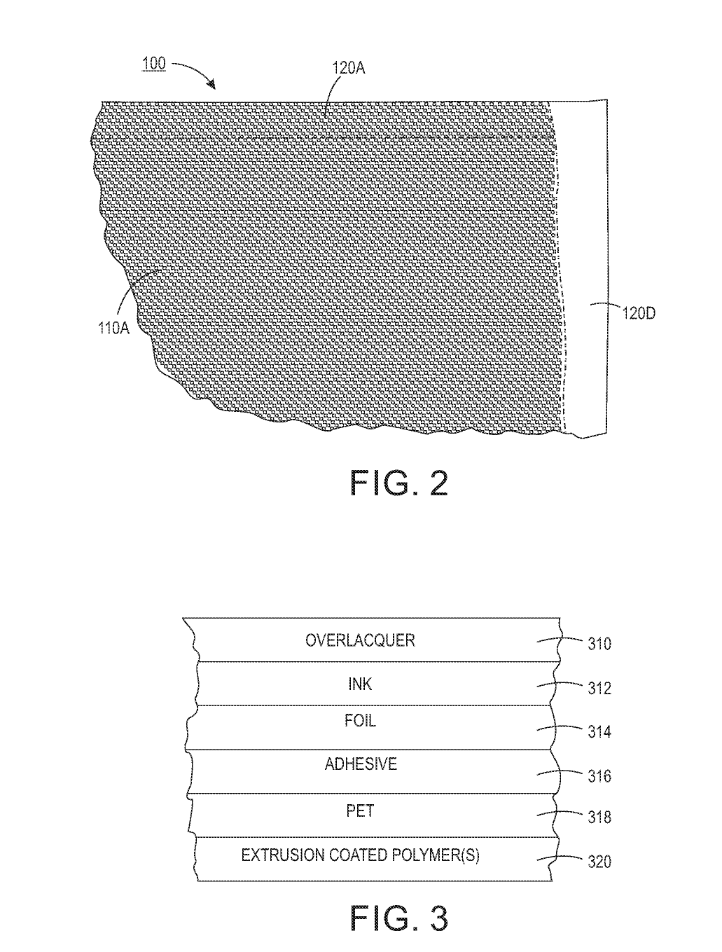

A three-side seal style package is illustrated, for example, in FIGS. 1A-1C, where the package 100 is formed from two pieces or films 110A, 110B of a layered material that are sealed about one or more edges 120A-D of the package. At least one edge 120D, as represented in FIG. 2, may not be sealed, or may be differently (e.g., lightly) sealed so as to allow the seal to be opened for access to the material therein. Moreover, the three-side seal style package 100 may further include one or more gussets 130 formed therein so that when filled with a product such as cream cheese, the package may more easily fill the volume within a box (not shown) or similar outer package for shipment and/or retail display. In one embodiment, the seal along at least edge 120D is a seal allowing separation of the two sheets of layered material 110A and 110B from one another without tearing.

The use of low initial heat sealing temperature (HSIT) polymers such as High VA containing EVA Resins or customized polymeric compounds made with high VA containing EVA resins were addressed. These may include resins or compounds from companies such as Arkema, AT Plastics, Bostik, Celanese Dupont, and Henkel. The use of multi-layer co-extrusion technology allows the use of polymer layers that optimize adhesion to the adjacent film within the structure (PET in this case) and optimize low HS IT for package sealing.

The co-extrusion resins could be of the type within the Bynel and/or Appeel family of Dupont resins. The disclosed alternatives provide structures that are adequate and provide sealing temperatures within a desirable range for this application (e.g., packaging of cream cheese).

While known that a wax layer has the ability to flow into the seal areas to “caulk” the gusset area as well as side seals, to provide a “peel-open” package, the wax does not always insure a hermetic seal. Hence, using wax as a sealant does not insure a hermetic seal. Several of the embodiments disclosed herein seek to replicate or improve upon the performance of the known package materials, including an embossed pattern may be placed into the foil and associated layers—for example, using a deep anilox roll that is employed to produce the pattern as shown in FIG. 2. The embossed pattern in layered materials 110A and 110B, may be applied to the embodiments of the new structure disclosed herein if desirable, and may be done either during or after the disclosed lamination process.

As noted above, and referring to FIG. 3, a general example of the layered structure would be: over-lacquer layer 310/ink layer 312/foil layer 314/adhesive layer 316/polyethylene terephthalate (PET) layer 318/extrusion coated polymer(s) layer 320. The general structure depicted can also be more specifically characterized by particular dimensions including layer thicknesses and/or application rates. For example, the following examples present different combinations that may be considered for the various layers, and the stated rates and thicknesses are intended to be targets and generally represent minimums unless otherwise indicated:
(i) Over-lacquer/Ink/Foil-0.00033″ or 0.000285″/Poly-Urethane Adhesive, in range of 1-3#/rm/48ga PET/Extrusion Coated Polymer in range of 10-15#/rm
(ii) Over-lacquer/Ink/Foil-0.00033″ or 0.000285″/Poly-Urethane Adhesive, in range of 1-3#/rm/48ga PET/Extrusion Coated COEX (Polymer 1/Polymer 2) in range of 10-15#/rm Total
(iii) Over-lacquer/Ink/Foil-0.00033″ or 0.000285″/Poly-Urethane Adhesive, in range of 1-3#/rm/48ga PET/Extrusion Coated Hot Melt in range of 10-15#/rm.

As will be appreciated and should be stressed, all of above options may also take the format of: Over-lacquer/Ink/Foil/PE Extrusion Lamination in range of 4-7#/rm/PET/Extrusion Coated Polymer(s).

### Experimental Results

The types of polymers and extrudable EVA based compounds that provide properties believed desirable for a packaging structure to replace a purely wax based heat-seal layer in the structure include the following, some of which may be more ideal or optimum for the use requirements. Compounds of high VA containing ethylene vinyl acetate (EVA) and polyethylene (PE) polymer, and possibly low percentages of wax, that may be added to latter polymers to enhance or alter the seal initiation temperature. The latter is shown in the graphs below, where some are more optimum or ideal, and the reason for presenting the differences is to illustrate that modifications are needed within commercially available compounds and that off-the-shelf solutions may be not be an ideal solution. The B-R is an example of how modifications facilitate a more ideal situation for HSIT. It should be appreciated that by merely taking off-the-shelf compounds the resulting structure may not provide ideal sealing or filling conditions. The other resins fall within a range that gives much higher HSIT's.

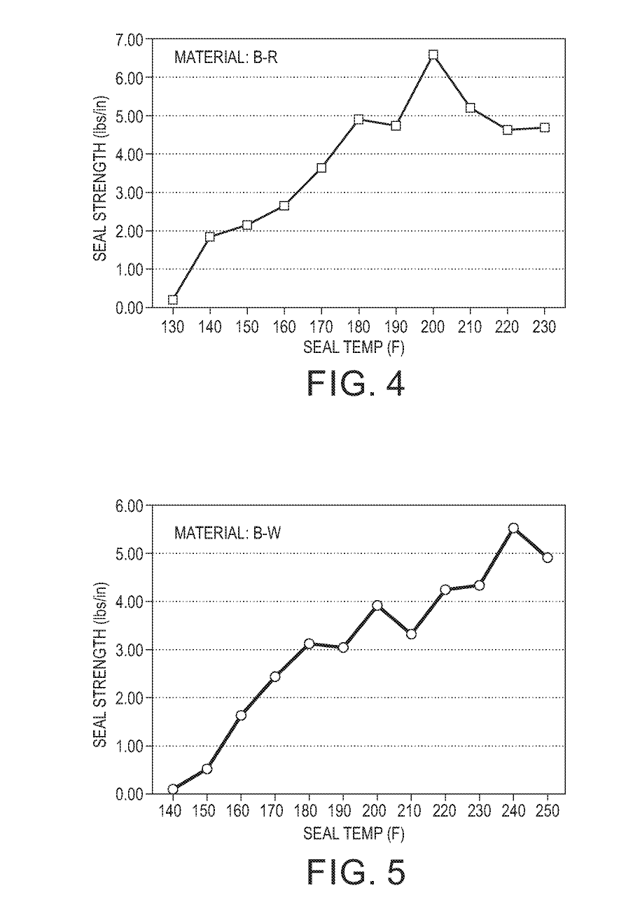

When such polymers and hot melts were extrusion coated onto structures having layers and characteristics noted above, these resins provided sealing results and seal curves (seal strength) as illustrated, for example in FIGS. 4-8. The data illustrates a range of sealing attributes and flow of the resins that provide a low HSIT yet would remain sealed during hot filling conditions.

For example, referring to FIGS. 4 and 5, depicted therein are two curves illustrating the performance (seal strength) of a sealant resin (B-W=unmodified (FIG. 5), B-R=modified sealant resin (FIG. 4)) which is a blend of polymers, along the lines of EVA-PE polymers which may include wax(es) that enhance or alter the HSIT. In the disclosed tests, a structure of 25# Paper/10190 PE/48ga PET was used and the material was sealed using a Mocon gradient sealer at 0.5 sec and a pressure of 40 psi, at various temperatures, as represented along the lower axes of each graph. And, in the case of FIG. 4, the packing material structures were prepared with a revised B-R sealant layer material that resulted in a shift to what may be a more optimum (lower strength at low temp) HSIT for the processing on conventional packing/filling equipment. Moreover, wax is included in the sealant resin, but not 100% wax, and as a result the resin does not have a high coat weight as compared with a conventional full wax sealant control. In producing the material, the air gap was changed to about 4″-5″ versus about 8″-9″ for other common extrusion resins.

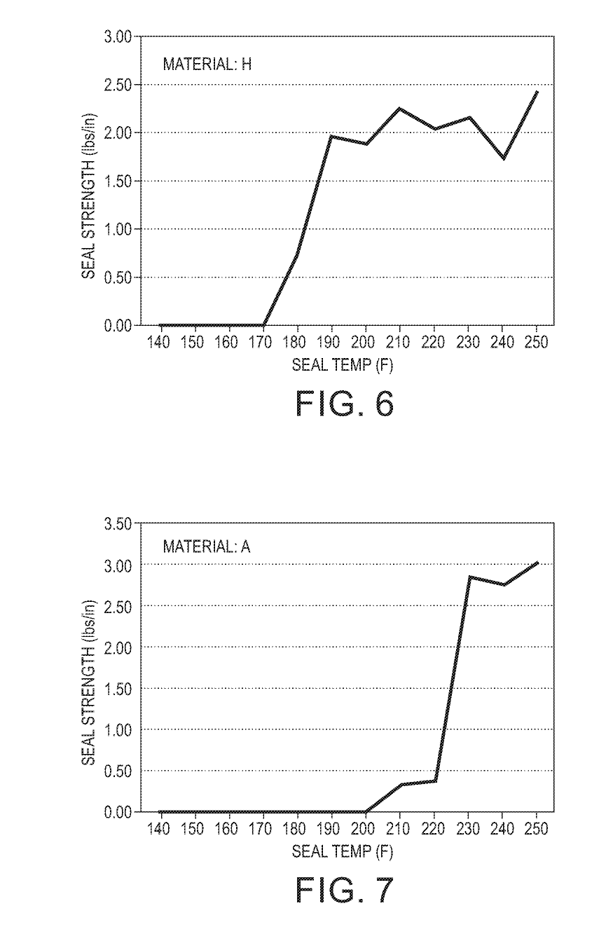

Referring to FIG. 6, depicted therein are the results of a trial performed on a packaging material having the following structure: 25# Paper/10# PE/48ga PET, where the material was sealed using a Mocon gradient sealer at 0.5 sec and a pressure of 40 psi. As noted, the resulting seal strength for the extrudable EVA (H) based compound sealant resin is reported in lbs/in at various seal temperatures. Similarly, FIG. 7 illustrates the results for proprietary compound resin (e.g., Appeel), again using the same structure and parameters set forth with respect to FIG. 6. These produce a different range of HSIT and sealing conditions and the graphed results are provided to illustrate the range of sealing for given polymers/compounds.

As will also be appreciated, as part of using these polymer materials, a special coated PET, as supplied to a converter, could be employed so one would not have to use special primers on that PET during the in-line lamination process—thereby saving both the cost of the primers as well as the need to include that operation in the manufacturing process.

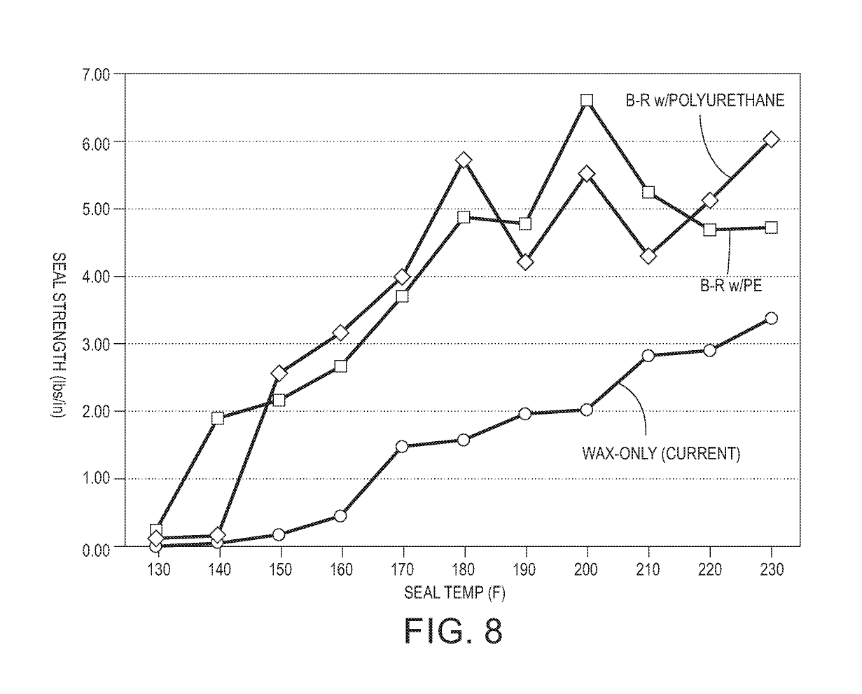

Turning next to FIG. 8, depicted therein is a comparative graph showing comparative results between a current wax-only sealant material (circles) and two improved sealant materials that were applied within the scope of FIG. 3. Specifically B-R was applied as the sealant in both a PE adhesive lamination (layer 316 in FIG. 3) as well as a polyurethane adhesive lamination (layer 316 in FIG. 3.). The tests were conducted in a manner similar to that described above, although the sample materials were once again sealed using the Mocon gradient sealer at lower pressure of 20 psi, for a period of 0.5 sec. As indicated, the squares curve represents the B-R (modified) resin/sealant material and the structure includes PE as the adhesive between the PET and the Foil. The diamonds curve is the same B-R (modified) resin material but with adhesive lamination (polyurethane adhesive) between the PET layer and the foil layer. The data illustrated by the graphs (curves) shows some of the subtle differences between PE and adhesive laminations.

Additional physical testing was conducted on the samples of FIG. 8, and the following table provides a representation of the resulting data:

B-R w/PE

| Test Name | UOM | Sample 1 | Sample 2 | Sample 3 | Average |
|---|---|---|---|---|---|
| Curl (MD) | degrees | 20 | 15 | 20 | 18.33 |
| Curl (CD) | degrees | 5 | 0 | 0 | 1.67 |
| Mullen Burst | psi | 47 | 45 | 46 | 46.00 |
| Deadfold | degrees | 10 | 15 | 5 | 10.00 |
| Deadfold | degrees | 0 | 0 | 0 | 0.00 |
| ***COF: Seal to Steel | - - - | 0.647 | - - - | - - - | 0.647 |
| (Kinetic) | | | | | |
| ***COF: Seal to Steel (Kinetic) | - - - | 0.542 | - - - | - - - | 0.542 |

B-R w/polyurethane

| Test Name | UOM | Sample 1 | Sample 2 | Sample 3 | Average |
|---|---|---|---|---|---|
| Curl (MD) | degrees | 10 | 10 | 0 | 6.67 |
| Curl (CD) | degrees | 5 | 5 | 0 | 3.33 |
| Mullen Burst | psi | 45 | 48 | 48 | 47.00 |
| Deadfold | degrees | 20 | 16 | 25 | 20.33 |
| Deadfold | degrees | 20 | 10 | 10 | 13.33 |
| ***COF: Seal to Steel | - - - | 0.491 | - - - | - - - | 0.491 |
| (Kinetic) | | | | | |
| ***COF: Seal to Steel (Kinetic) | - - - | 0.533 | - - - | - - - | 0.533 |

***All COF's tested using 200 g sled

### Processing During Extrusion Lamination

For certain sealant options extrusion processing conditions had to be adjusted to accommodate the polymers. These include adjustments in air gap (increasing air gap from 5″ to 7″) chill roll temperature (decreasing temperature by 10 to 15 ° F.), and insuring the chill roll matte surface has a surface roughness. The Ra value (Average Roughness) may be in the range of about 70 to 90 Ra for the Matte Chill Roll used for processing the wax replacement structures. While this Ra value may not be unique by itself, it provided the proper release from the chill roll for the polymers selected, i.e.: B-R and B-W, along with the proper air gap, chill roll temperature. The chill roll temperature was about 50-55 F for processing on the lines and is anticipated for production.

In one method of production, the general flow or processing for a structure such as disclosed above would be to combine the foil layer 314 with the PET layer 318 (and adhesive 316) as part of either an adhesive or extrusion lamination process and then apply the sealant polymer (layer 320) in-line to the exposed PET surface.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A packaging material structure for use in a package, comprising:
a foil, said foil including on one surface thereof an ink layer;
an adhesive layer on an opposite surface of the foil layer; and
a polyethylene terephthalate (PET) layer including at least one extrusion coated polymer thereon.

2. The packaging material structure according to claim 1, wherein said foil layer further includes an over-lacquer layer on said ink layer.

3. The packaging material structure according to claim 1, wherein at least said foil is embossed.

4. The packaging material structure according to claim 1, wherein the thickness of said foil is in the range of 0.000285″ to 0.00033″, where said adhesive layer includes a poly-urethane adhesive applied at a rate in a range of 1-3 lbs./3000 sq. ft., where said PET layer has a thickness of at least 48 gauge, and where the extrusion coated polymer is applied at a rate within a range of 10-15 lbs./3000 sq. ft.

5. The packaging material structure according to claim 1, wherein the thickness of said foil is in the range of 0.000285″ to 0.00033″, where said adhesive layer includes a poly-urethane adhesive applied at a rate in a range of 1-3 lbs./3000 sq. ft., where said PET layer has a thickness of at least 48 gauge, and where the extrusion coated polymer is a co-extrusion of a first and a second polymer applied at a rate within a range of 10-15 lbs./3000 sq. ft.

6. The packaging material structure according to claim 1, wherein the thickness of said foil is in the range of 0.000285″ to 0.00033″, where said adhesive layer includes a poly-urethane adhesive applied at a rate in a range of about 1-3 lbs./3000 sq. ft., where said PET layer has a thickness of at least 48 gauge, and where the extrusion coated polymer is an extrusion coated EVA based compound applied at a rate within a range of 10-15 lbs./3000 sq. ft.

7. The packaging material structure according to claim 1, further including a polyethylene (PE) extrusion lamination layer between the foil and the PET layer, where said polyethylene (PE) extrusion lamination layer is applied at a rate within a range of 4-7 lbs./3000 sq. ft.

8. The packaging material structure according to claim 1, wherein the material structure is used in a three-side seal style package.

9. The packaging material structure according to claim 1, wherein the material structure is used in a flow wrap style package.

10. A method of production of the material structure of claim 1, including:
combining the foil layer with the PET layer with integral adhesive; and
applying the sealant polymer to the exposed PET surface.

11. The method according to claim 10, wherein the foil and PET layers are combined as part of an adhesive lamination process.

12. The method according to claim 10, wherein the foil and PET layers are combined as part of an extrusion lamination process.

13. A method of production of a material structure for converting a package, comprising:
applying an ink layer on one surface of a foil layer;
applying an adhesive layer on an opposite surface of the foil layer; and
applying a polyethylene terephthalate (PET) layer over said adhesive layer, said PET layer further including at least one extrusion coated polymer thereon.

14. The method according to claim 13, wherein an over-lacquer layer is applied over said ink layer.

15. The method according to claim 13, wherein the thickness of said foil is in the range of 0.000285″ to 0.00033″, where said adhesive layer includes a poly-urethane adhesive applied at a rate in a range of 1-3 lbs./3000 sq. ft., where said PET layer has a thickness of at least 48 gauge, and where the extrusion coated polymer is applied at a rate within a range of 10-15 lbs./3000 sq. ft.

16. The method according to claim 13, wherein the thickness of said foil is in the range of 0.000285″ to 0.00033″, where said adhesive layer includes a poly-urethane adhesive applied at a rate in a range of 1-3 lbs./3000 sq. ft., where said PET layer has a thickness of at least 48 gauge, and where the extrusion coated polymer is a co-extrusion of a first and a second polymer applied at a rate within a range of 10-15 lbs./3000 sq. ft.

17. The method according to claim 13, wherein the thickness of said foil is in the range of 0.000285″ to 0.00033″, where said adhesive layer includes a poly-urethane adhesive applied at a rate in a range of about 1-3 lbs./3000 sq. ft., where said PET layer has a thickness of at least 48 gauge, and where the extrusion coated polymer is an extrusion coated EVA based compound applied at a rate within a range of 10-15 lbs./3000 sq. ft.

18. The method according to claim 13, further including a polyethylene (PE) extrusion lamination layer between the foil and the PET layer, where said polyethylene (PE) extrusion lamination layer is applied at a rate within a range of 4-7 lbs./3000 sq. ft.

19. The method according to claim 13, further including combining the foil layer with the PET layer with integral adhesive, and applying the sealant polymer to the exposed PET surface.
